(19) United States
(12) Patent Application Publication
(10) Pub. No.: US 2016/0054861 A1
(43) Pub. Date: Feb. 25, 2016

(54) TOUCH DISPLAY DEVICE AND WINDOW SHARING METHOD THEREOF

(71) Applicant: Wistron Corporation, New Taipei City (TW)

(72) Inventor: Jenny Shan, New Taipei City (TW)

(21) Appl. No.: 14/583,203

(22) Filed: Dec. 26, 2014

(30) Foreign Application Priority Data
Aug. 25, 2014 (CN) 201410422009.1

(51) Int. Cl. G06F 3/0481; G06F 3/0484; G06F 3/0488

(52) U.S. Cl. CPC G06F 3/0481; G06F 3/04883; G06F 3/04845; G06F 2203/04803; G06F 2203/04808

(57) ABSTRACT

A touch display device includes a touch display unit and a processing unit. The touch display unit displays N windows, wherein the N windows face a primary operation direction and are in an editable mode, and N is a positive integer. The processing unit is connected to the touch display unit. When a first touch gesture is performed on the touch display unit to rotate an i-th window of the N windows from the primary operation direction to a secondary operation direction, the processing unit switches the i-th window from the editable mode to a read-only mode, wherein i is a positive integer smaller than or equal to N.

### BACKGROUND OF THE INVENTION

1. Field of the Invention

The invention relates to a touch display device and a window sharing method thereof and, more particularly, to a touch display device and a window sharing method thereof capable of rotating a window to share the window with a person.

2. Description of the Prior Art

As technology advances and develops, various touch display devices including a mobile phone, a personal digital assistant, a tablet computer, a notebook computer, and so on are considered a necessity by a lot of people in their daily lives. When using the touch display device, a user may open a lot of windows to execute various applications. When the user wants to share the content displayed in a specific window with a person, the user always has to hand over the touch display device to the person. After the person browses the specific window and then hands over the touch display device to the user, the user can continue to use the touch display device. In other words, the user has to waste time to wait the person to browse the specific window and it is inconvenient in use.

### SUMMARY OF THE INVENTION

The invention provides a touch display device and a window sharing method thereof capable of rotating a window to share the window with a person, so as to solve the aforesaid problems.

According to the claimed invention, a touch display device comprises a touch display unit and a processing unit. The touch display unit displays N windows, wherein the N windows face a primary operation direction and are in an editable mode, and N is a positive integer. The processing unit is connected to the touch display unit. When a first touch gesture is performed on the touch display unit to rotate an i-th window of the N windows from the primary operation direction to a secondary operation direction, the processing unit switches the i-th window from the editable mode to a read-only mode, wherein i is a positive integer smaller than or equal to N.

According to the claimed invention, when a second touch gesture is performed on the touch display unit to rotate the i-th window from the secondary operation direction to the primary operation direction, the processing unit switches the i-th window from the read-only mode to the editable mode.

According to the claimed invention, each of the N windows displays a mode button. When the mode button is triggered, the processing unit switches the window, which is in the editable mode, to the read-only mode and switches the window, which is in the read-only mode, to the editable mode.

According to the claimed invention, the touch display device further comprises a storage unit connected to the processing unit. The storage unit stores a plurality of touch gestures and a plurality of predetermined angles, wherein each of the touch gestures is corresponding to one of the predetermined angles. The processing unit rotates the i-th window by the predetermined angle corresponding to the touch gesture.

According to the claimed invention, the predetermined angle is equal to 90 degrees, 180 degrees or 270 degrees.

According to the claimed invention, a trajectory of the touch gesture is an arc, a numeral, a symbol or a pattern.

According to the claimed invention, a window sharing method is applied to a touch display device. The touch display device comprises a touch display unit. The window sharing method comprises steps of displaying N windows in the touch display unit, wherein the N windows face a primary operation direction and are in an editable mode, and N is a positive integer; performing a first touch gesture on the touch display unit to rotate an i-th window of the N windows from the primary operation direction to a secondary operation direction, wherein i is a positive integer smaller than or equal to N; and switching the i-th window from the editable mode to a read-only mode.

According to the claimed invention, the window sharing method further comprises steps of performing a second touch gesture on the touch display unit to rotate the i-th window from the secondary operation direction to the primary operation direction; and switching the i-th window from the read-only mode to the editable mode.

According to the claimed invention, the window sharing method further comprises steps of displaying a mode button in each of the N windows; triggering the mode button; and switching the window, which is in the editable mode, to the read-only mode and switching the window, which is in the read-only mode, to the editable mode.

According to the claimed invention, the window sharing method further comprises steps of storing a plurality of touch gestures and a plurality of predetermined angles, wherein each of the touch gestures is corresponding to one of the predetermined angles; and rotating the i-th window by the predetermined angle corresponding to the touch gesture.

According to the claimed invention, the predetermined angle is equal to 90 degrees, 180 degrees or 270 degrees.

According to the claimed invention, a trajectory of the touch gesture is an arc, a numeral, a symbol or a pattern.

As mentioned in the above, when a user wants to share the content displayed in a specific window with a person, the user can perform a touch gesture to rotate the specific window to the direction where the person is located at without handing over the touch display device to the person. Accordingly, the user can continue to operate other windows while the person is browsing the specific window. Furthermore, to prevent the touch display device from being overloaded resulted from that the user and the person edit different windows at the same time, the invention sets the window, which faces the user (i.e. the aforesaid primary direction), to be the editable mode and sets the window, which faces the person (i.e. the aforesaid secondary direction), to be the read-only mode. In other words, the person can only browse or close the rotated window but cannot execute other editing commands (e.g. open a new window, open a link, edit a document, store a content, etc.).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a touch display device according to an embodiment of the invention.

FIG. 2 is a schematic diagram illustrating four windows displayed in the touch display unit shown in FIG. 1, wherein the four windows face a primary operation direction.

FIG. 3 is a schematic diagram illustrating that three windows shown in FIG. 1 are rotated from the primary operation direction to a secondary operation direction.

FIG. 4 is a flowchart illustrating a window sharing method according to an embodiment of the invention.

FIG. 5 is a schematic diagram illustrating that the mode button of the window shown in FIG. 3 is triggered.

### DETAILED DESCRIPTION

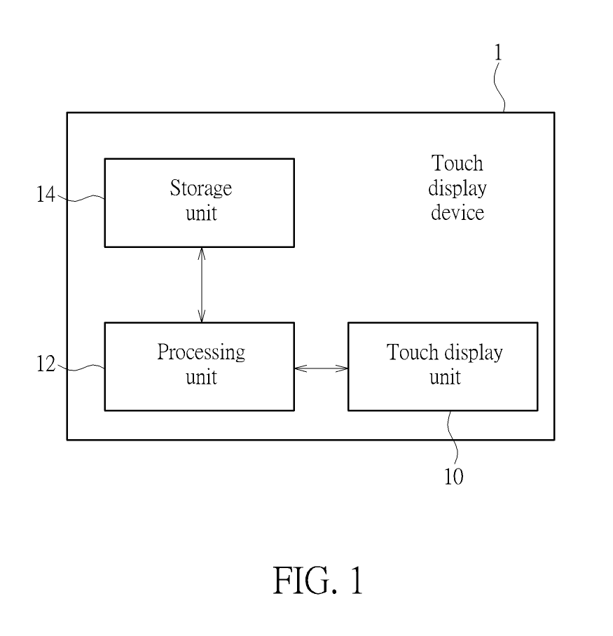

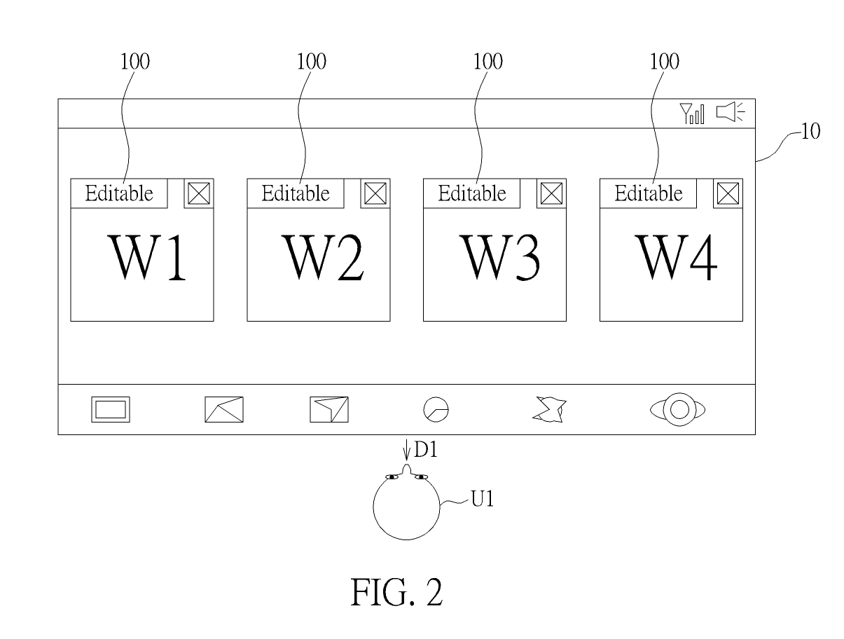

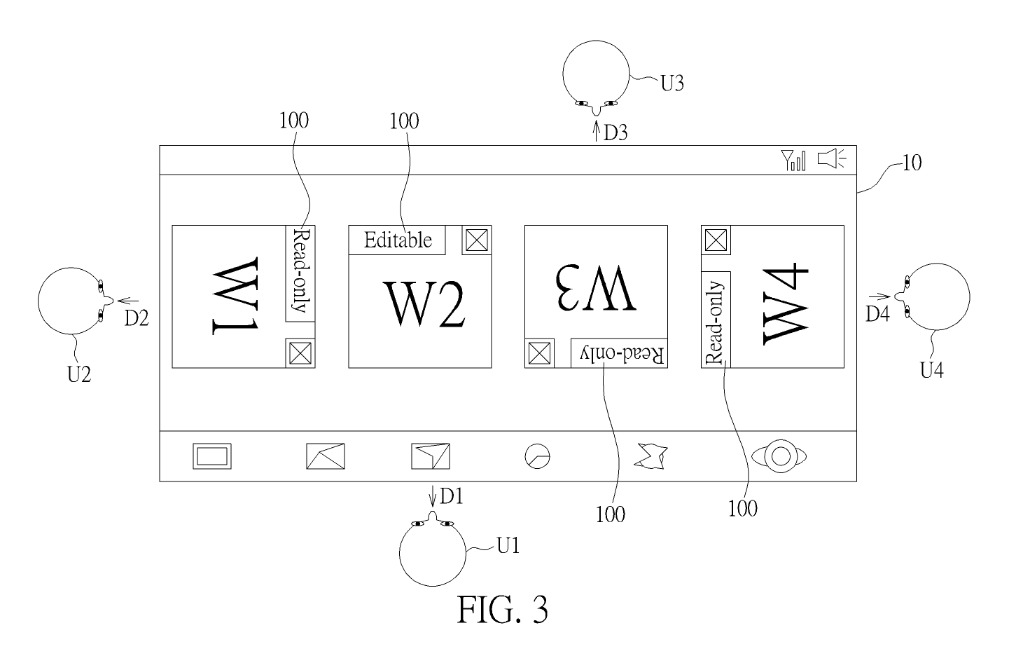

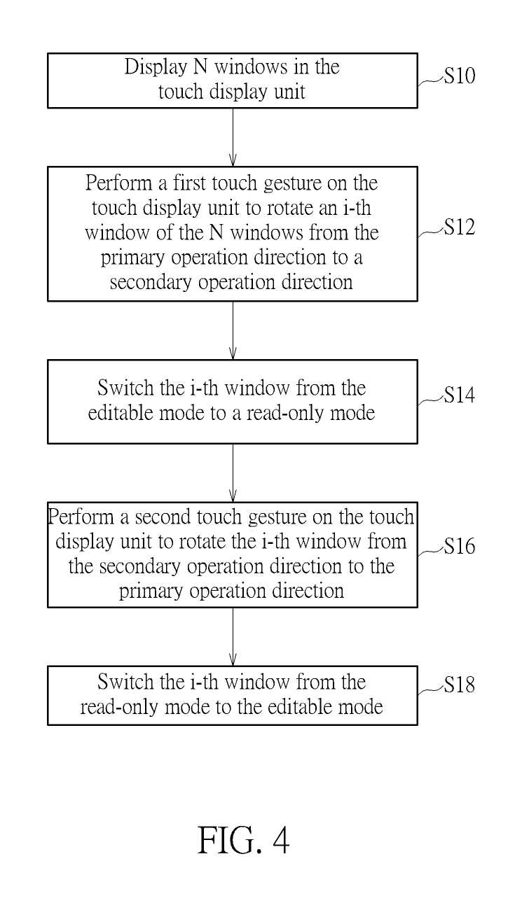

Referring to FIGS. 1 to 4, FIG. 1 is a functional block diagram illustrating a touch display device 1 according to an embodiment of the invention; FIG. 2 is a schematic diagram illustrating four windows W1-W4 displayed in the touch display unit 10 shown in FIG. 1, wherein the four windows W1-W4 face a primary operation direction D1; FIG. 3 is a schematic diagram illustrating that three windows W1, W3, W4 shown in FIG. 1 are rotated from the primary operation direction D1 to a secondary operation direction D2; and FIG. 4 is a flowchart illustrating a window sharing method according to an embodiment of the invention. The window sharing method shown in FIG. 4 can be implemented by the touch display device 1 shown in FIG. 1.

As shown in FIG. 1, the touch display device 1 comprises a touch display unit 10, a processing unit 12 and a storage unit 14, wherein the processing unit 10 is connected to the touch display unit 12 and the storage unit 14. In practical applications, the touch display device 1 maybe a mobile phone, a personal digital assistant, a tablet computer, a notebook computer or other electronic devices with touch display function; the touch display unit 10 may consist of a touch panel and a display panel; the processing unit 12 may be a processor or controller with data calculating/processing function; and the storage unit 14 may be a hard disc, a memory or other data storage devices. In general, the touch display device 1 may be further equipped with some necessary hardware or software components for specific purposes, such as a power supply, an operating system, a communication module, etc., and it depends on practical applications.

In this embodiment, the storage unit 14 may store a plurality of touch gestures and a plurality of predetermined angles, wherein each of the touch gestures is corresponding to one of the predetermined angles. The aforesaid predetermined angle may be equal to 90 degrees, 180 degrees or 270 degrees and a trajectory of the aforesaid touch gesture may be an arc, a numeral, a symbol or a pattern. Referring to tables 1 to 3, tables 1 to 3 show the relation between a plurality of touch gestures and a plurality of predetermined angles according to different embodiments.

TABLE 1

| Trajectory of touch gesture | Predetermined angle |
|---|---|
| Arc of one fourth circle | 90 degrees clockwise |
| clockwise | |
| Arc of half circle clockwise | 180 degrees clockwise |
| Arc of three fourth circle | 270 degrees clockwise |
| clockwise | |
| Arc of one fourth circle | 90 degrees counterclockwise |
| counterclockwise | |
| Arc of half circle | 180 degrees counterclockwise |
| counterclockwise | |
| Arc of three fourth circle | 270 degrees counterclockwise |
| counterclockwise | |

TABLE 2

| Trajectory of touch gesture | Predetermined angle |
|---|---|
| → | 90 degrees clockwise or 270 |
| | degrees counterclockwise |
| ↑ | 180 degrees clockwise or 180 |
| | degrees counterclockwise |
| ← | 270 degrees clockwise or 90 |
| | degrees counterclockwise |

TABLE 3

| Trajectory of touch gesture | Predetermined angle |
|---|---|
| 1 | 90 degrees clockwise |
| 2 | 180 degrees clockwise |
| 3 | 270 degrees clockwise |
| 4 | 90 degrees counterclockwise |
| 5 | 180 degrees counterclockwise |
| 6 | 270 degrees counterclockwise |

It should be noted that the relation between the touch gestures and the predetermined angles may be determined according to practical applications and are not limited to the embodiments shown in the tables 1 to 3.

As shown in FIG. 2, the touch display unit 10 may display N windows according to the operation of a user U1 (step S10 in FIG. 4), wherein the N windows face a primary operation direction D1 and are in an editable mode, and N is a positive integer. The aforesaid primary operation direction D1 is the direction where the user U1 is located at. In this embodiment, the touch display unit 10 displays four windows W1-W4 (i.e. N=4). However, the number of windows displayed by the touch display device 10 may be determined according to the operation of the user U1 and is not limited to four. Furthermore, each of the windows W1-W4 displays a mode button 100 for recognizing a current mode of each window W1-W4.

In this embodiment, when the user U1 performs a first touch gesture of the invention on any one of the windows W1-W4, the processing unit 12 rotates the window by a predetermined angle corresponding to the first touch gesture. As shown in FIG. 3, when the user U1 wants to share the content displayed in the first window W1 with another user U2, the user U1 may select the first window W1 and perform the first touch gesture of an arc of one fourth circle clockwise (as shown in the table 1, for example), so as to rotate the first window W1 from the primary operation direction D1 to a secondary operation direction D2 in 90 degrees clockwise (step S12 in FIG. 4). At this time, the processing unit 12 switches the first window W1 from the editable mode to a read-only mode (step S14 in FIG. 4), as shown by the mode button 100. Similarly, the user U1 may also share the contents displayed in the third window W3 and the fourth window W4 with other users U3, U4 according to the aforesaid operations. Since the rotated windows W1, W3, W4 are in the read-only mode, the users U2, U3, U4 can only browse or close the rotated windows W1, W3, W4 but cannot execute other editing commands (e.g. open a new window, open a link, edit a document, store a content, etc.). In other words, only the user U1 can execute the editing commands for the second window W2, which faces the primary operation direction D1. Accordingly, the invention can prevent the touch display device 1 from being overloaded resulted from that the users U1-U4 edit different windows W1-W4 at the same time.

It should be noted that when the user U1 selects the first window W1 again and performs a second touch gesture of an arc of one fourth circle counterclockwise on the touch display unit 10 (as shown in the table, for example) to rotate the first window W1 from the secondary operation direction D2 to the primary operation direction D1 in 90 degrees counterclockwise (step S16 in FIG. 4), the processing unit 12 switches the first window W1 from the read-only mode to the editable mode accordingly (step S18 in FIG. 4). At this time, the user U1 can execute the editing commands for the first window W1, which faces the primary operation direction D1.

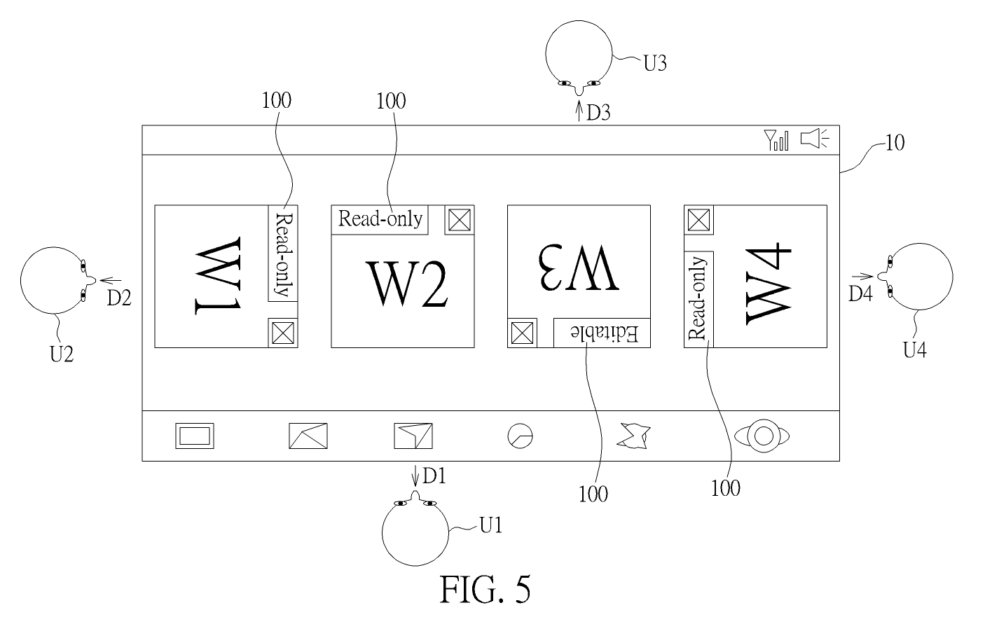

Referring to FIG. 5, FIG. 5 is a schematic diagram illustrating that the mode button 100 of the window W3 shown in FIG. 3 is triggered. As shown in FIG. 5, if the user U3 wants to execute the editing commands for the window W3, the user U3 may click the mode button 100 of the window W3. When the mode button 100 of the window W3 is triggered, the processing unit 12 switches the window W2, which is in the editable mode, to the read-only mode and switches the window W3, which is in the read-only mode, to the editable mode. Accordingly, the user U3 can execute the editing commands for the window W3.

It should be noted that the control logic of the window sharing method of the invention can be implemented by software. Needless to say, each part or function of the control logic may be implemented by software, hardware or the combination thereof. Moreover, the control logic of the window sharing method of the invention can be embodied by a computer readable storage medium, wherein the computer readable storage medium stores instructions, which can be executed by the touch display device, so as to generate control command for executing corresponding function.

As mentioned in the above, when a user wants to share the content displayed in a specific window with a person, the user can perform a touch gesture to rotate the specific window to the direction where the person is located at without handing over the touch display device to the person. Accordingly, the user can continue to operate other windows while the person is browsing the specific window. Furthermore, to prevent the touch display device from being overloaded resulted from that the user and the person edit different windows at the same time, the invention sets the window, which faces the user (i.e. the aforesaid primary direction), to be the editable mode and sets the window, which faces the person (i.e. the aforesaid secondary direction), to be the read-only mode. In other words, the person can only browse or close the rotated window but cannot execute other editing commands (e.g. open a new window, open a link, edit a document, store a content, etc.).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device comprising:
a touch display unit displaying N windows, the N windows facing a primary operation direction and being in an editable mode, N being a positive integer; and
a processing unit connected to the touch display unit, when a first touch gesture is performed on the touch display unit to rotate an i-th window of the N windows from the primary operation direction to a secondary operation direction, the processing unit switching the i-th window from the editable mode to a read-only mode, i being a positive integer smaller than or equal to N.

2. The touch display device of claim 1, wherein when a second touch gesture is performed on the touch display unit to rotate the i-th window from the secondary operation direction to the primary operation direction, the processing unit switches the i-th window from the read-only mode to the editable mode.

3. The touch display device of claim 2, wherein each of the N windows displays a mode button, when the mode button is triggered, the processing unit switches the window, which is in the editable mode, to the read-only mode and switches the window, which is in the read-only mode, to the editable mode.

4. The touch display device of claim 3, further comprising a storage unit connected to the processing unit, the storage unit storing a plurality of touch gestures and a plurality of predetermined angles, each of the touch gestures being corresponding to one of the predetermined angles, the processing unit rotating the i-th window by the predetermined angle corresponding to the touch gesture.

5. The touch display device of claim 4, wherein the predetermined angle is equal to 90 degrees, 180 degrees or 270 degrees.

6. The touch display device of claim 5, wherein a trajectory of the touch gesture is an arc, a numeral, a symbol or a pattern.

7. A window sharing method applied to a touch display device, the touch display device comprising a touch display unit, the window sharing method comprising:
displaying N windows in the touch display unit, wherein the N windows face a primary operation direction and are in an editable mode, and N is a positive integer;
performing a first touch gesture on the touch display unit to rotate an i-th window of the N windows from the primary operation direction to a secondary operation direction, wherein i is a positive integer smaller than or equal to N; and
switching the i-th window from the editable mode to a read-only mode.

8. The window sharing method of claim 7, further comprising:
performing a second touch gesture on the touch display unit to rotate the i-th window from the secondary operation direction to the primary operation direction; and
switching the i-th window from the read-only mode to the editable mode.

9. The window sharing method of claim 8, further comprising:
displaying a mode button in each of the N windows;
triggering the mode button; and
switching the window, which is in the editable mode, to the read-only mode and switching the window, which is in the read-only mode, to the editable mode.

10. The window sharing method of claim 9, further comprising:
storing a plurality of touch gestures and a plurality of predetermined angles, wherein each of the touch gestures is corresponding to one of the predetermined angles; and
rotating the i-th window by the predetermined angle corresponding to the touch gesture.

11. The window sharing method of claim 10, wherein the predetermined angle is equal to 90 degrees, 180 degrees or 270 degrees.

12. The window sharing method of claim 11, wherein a trajectory of the touch gesture is an arc, a numeral, a symbol or a pattern.
